(19) United States
(12) Patent Application Publication
(10) Pub. No.: US 2020/0133270 A1
(43) Pub. Date: Apr. 30, 2020

(54) LIDAR DEVICE WITH CYLINDRICAL LENS FOR AUTONOMOUS DRIVING VEHICLES

(71) Applicant: Baidu USA LLC, Sunnyvale, CA (US)

(72) Inventors: Yang HAN, Sunnyvale, CA (US); Yaoming SHEN, Sunnyvale, CA (US); Xiangfei ZHOU, Sunnyvale, CA (US)

(21) Appl. No.: 16/176,953

(22) Filed: Oct. 31, 2018

(51) Int. Cl. G05D 1/00; G05D 1/02; G01S 17/89; G01S 17/93; G01S 7/481; G01S 7/486

(52) U.S. Cl. CPC G05D 1/0088; G05D 1/021; G01S 17/89; B60L 2260/32; G01S 7/4817; G01S 7/4865; G05D 2201/0213; G01S 17/936

(57) ABSTRACT

A LIDAR scanning system uses a combination of a laser emitter, a scanning mirror which scans in a first plane, a diffuser which diffuses emitted laser beams in a second plane, perpendicular to the first plane. A focusing optic focuses a reflection of a laser beam, reflected off of an object, onto a detector. The focusing optic focuses the reflection of the reflection of the laser beam at least in the first plane, and may also focus the reflection of the laser beam in the second plane. A peak magnitude of the detector, and a time which the peak occurred, relative to the time at which the laser beam was emitted (“time of flight”), and LIDAR information is generated from peak magnitude and time of flight. The LIDAR scanning system can be used in an autonomous driving vehicle (ADV) to assist in navigating the ADV.

### TECHNICAL FIELD

Embodiments of the present disclosure relate generally to LIDAR sensors for use with an autonomous driving vehicle (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

One of the onboard sensors in an autonomous driving vehicle (ADV) is a light detection and ranging (“LIDAR”). LIDAR can be used by an ADV to detect objects surrounding the ADV while driving. LIDAR can also be used to generate and/or update a high-definition map representing objects surrounding the ADV, such as buildings, roadways, signs, trees, and other objects that may appear in a high definition map.

For onboard LIDAR to be effective in detecting objects surrounding the ADV, the scanning for objects must be performed quickly, reliably, and capture as much information surrounding the ADV as possible. When an object to be scanned is far from the LIDAR device, e.g. at 100 meters, the intensity of a laser beam reflected by a scanned object may be low. Also it is possible for the laser beam reflected by a scanned object to miss, or “fall off” the detector and not be properly measured.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle (ADV) according to one embodiment.

FIG. 3 is a block diagram illustrating an example of a perception and planning system used with an ADV according to one embodiment

FIGS. 4A and 4B are block diagrams illustrating a LIDAR sensor system that incorporates a focusing lens, such as a concave lens, and a diffuser to perform peak detection of a reflection of an initial laser beam off of an object scanned by the LIDAR sensor system, according to one embodiment.

FIG. 5 illustrates a method of determining a peak magnitude, and a time at which the peak magnitude occurs, in a LIDAR sensor system that incorporates a focusing lens and a diffuser to perform peak detection of a reflection of initial laser beam reflected off of an object scanned by a LIDAR system, according to some embodiments.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

In a first embodiment, a LIDAR device for use in an autonomous driving vehicle (ADV), includes a laser emitter, a focusing optic, a detector, a peak detection module, and a processing module. In an embodiment, the LIDAR device can further include a diffusing optic. In an embodiment, the diffusing optic can be a linear diffuser. The laser emitter can emit a sequence of laser beams in a first plane. A initial laser beam, and each subsequent beam in the sequence of laser beams, can be diffused, by the diffusing optic, in a second plane perpendicular to the first plane. The diffused laser beam is then reflected off of an object. The reflected laser beam can be focused onto the detector by the focusing optic. In an embodiment, the reflected laser beam can be focused onto the detector in the first plane. In an embodiment, the reflected laser beam can additionally, or alternatively, be focused onto the detector in the second plane. The focusing optic can be any of a spherical concave lens, a convex lens, a biconic lens, or an imaging lens. The peak detection module can detect a peak magnitude of the reflected (optionally diffused) initial laser beam by reading the detector. The detector can be a single photodiode, a small array of photodiodes (e.g. 4 or 8 photodiodes), or other light detecting device. The peak detection module can also determine a time at which the peak magnitude occurred with respect to the time of emitting the laser pulse whose reflection is being focused and detected. The processing module can generate LIDAR information that includes an intensity of the reflected laser beam, correlated to the peak magnitude of the focused reflected laser beam, and a “time of flight” for the reflected laser beam. The time of flight can be converted to from the LIDAR device of the object that reflected the laser beam.

In second embodiment, an autonomous driving vehicle (ADV) can include the above LIDAR device and a perception and planning system that can receive the LIDAR information generated by the LIDAR device to perceive a driving environment surrounding the ADV and to control the ADV to navigate the driving environment.

In a third embodiment, a method of generating LIDAR information can be performed on a LIDAR device that includes a laser emitter, a detector, a focusing optic, a peak detector module, and a processing module coupled to the peak detector module. The LIDAR device can also include a diffuser. The method includes emitting, emitting, by the laser emitter, an first laser beam in a sequence of laser beams in a first plane. The method also includes focusing, by the focusing optic, a reflection of the first laser beam off of an object, onto the detector, the focusing at least in the first plane. In embodiment, the method can include diffusing, by the diffusing optic, the reflected laser beam in a second plane that is perpendicular to the first plane. The method can further include receiving, by the detector, the focused reflection of the first laser beam, and determining, by the peak detector module, a peak magnitude of the focused reflection of the laser beam and a time at which the peak magnitude occurred relative to the emitting of the laser beam. Then, the method generates, by the processing module, LIDAR information for the peak magnitude and a time-of-flight from emitting the laser beam to the time at which the peak magnitude of the reflection of the laser beam occurred. The LIDAR information can be utilized to navigate the ADV responsive to one or more obstacles detected by the LIDAR device. In an embodiment, the focusing optic can focus the reflected first laser beam in the first plane. In an embodiment, the focusing optic can also focus the reflected first laser beam in the second plane. The focusing optic can be any of a biconic lens, a cylindrical lens, a concave lens, a convex lens, a spherical lens, or an imaging lens.

In forth embodiment, any of the above method operations can be implemented by executing instructions stored on a non-transitory computer-readable medium, the instructions executed by a processing system of the ADV that includes at least one hardware processor.

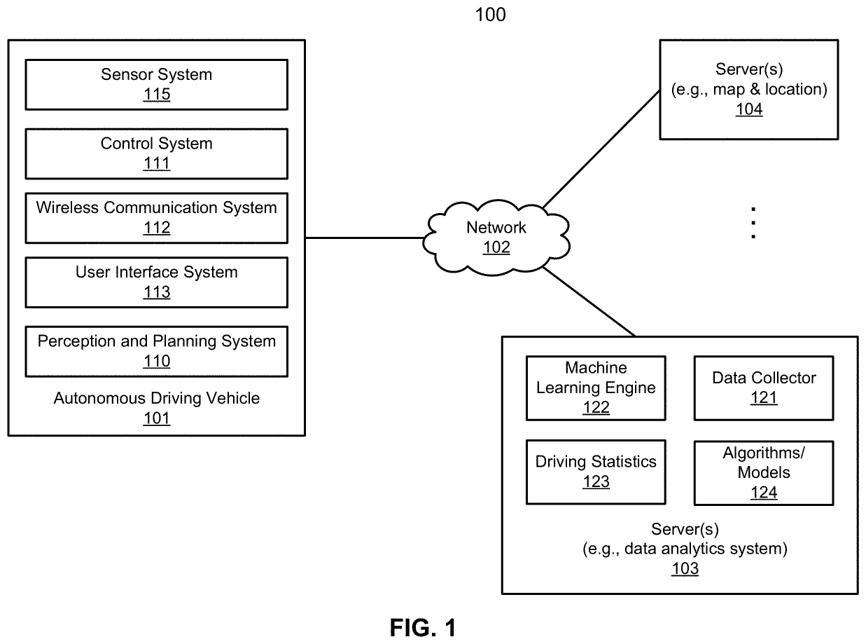

FIG. 1 is a block diagram illustrating an autonomous vehicle network configuration according to one embodiment of the disclosure. Referring to FIG. 1, network configuration 100 includes autonomous vehicle 101 that may be communicatively coupled to one or more servers 103-104 over a network 102. Although there is one autonomous vehicle shown, multiple autonomous vehicles can be coupled to each other and/or coupled to servers 103-104 over network 102. Network 102 may be any type of network such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) severs, or location servers, etc.

An autonomous driving vehicle (ADV) 101 refers to a vehicle that can be configured to operate in an autonomous mode in which the vehicle navigates through an environment with little or no input from a driver. Such an autonomous driving vehicle can include a sensor system 115 having one or more sensors that are configured to detect information about the environment in which the ADV 101 operates. The ADV 101 and its associated controller(s) use the detected information to navigate through the environment. Autonomous driving vehicle 101 can operate in a manual mode, a full autonomous mode, or a partial autonomous mode. In a manual mode, the ADV 101 can be operated by a human driver with little, or no, assistance for logic onboard the autonomous vehicle. In full autonomous mode, the ADV 101 can be operated using little, or no, human driver assistance. In partial autonomous mode, ADV 101 can be operated with some or all driving logic subsystems active, and a human driver providing some driving control inputs.

In one embodiment, autonomous driving vehicle 101 includes, but is not limited to, perception and planning system 110, vehicle control system 111, wireless communication system 112, user interface system 113, infotainment system 114, and sensor system 115. Autonomous vehicle 101 may further include certain common components included in ordinary vehicles, such as, an engine, wheels, steering wheel, transmission, etc., which may be controlled by vehicle control system 111 and/or perception and planning system 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

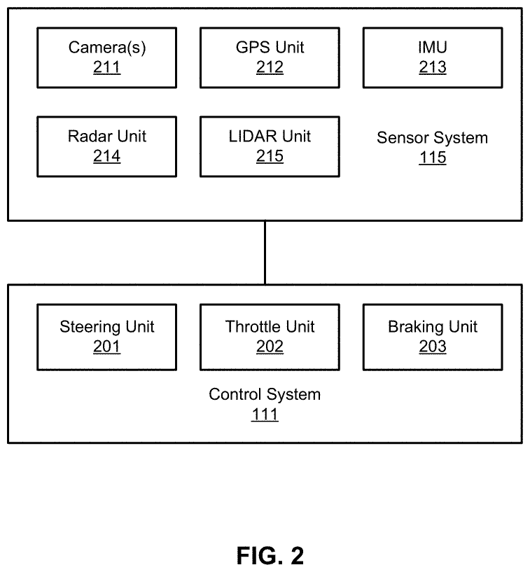

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the autonomous vehicle. IMU unit 213 may sense position and orientation changes of the autonomous vehicle based on inertial acceleration. Radar unit 214 may represent a system that utilizes radio signals to sense objects within the local environment of the autonomous vehicle. In some embodiments, in addition to sensing objects, radar unit 214 may additionally sense the speed and/or heading of the objects. LIDAR unit 215 may sense objects in the environment in which the autonomous vehicle is located using lasers. LIDAR unit 215 could include one or more laser sources, a laser scanner, one or more detectors, a diffusing optic, and a focusing optic, among other system components. LIDAR sensor 215 can include a plurality of sensor types to perform the task of detecting a peak magnitude of a reflected initial laser beam, reflected off of an object surrounding the autonomous vehicle, and a time at which the peak magnitude of the reflected initial laser beam occurred. In an embodiment, a detection module can determine a peak magnitude of the reflection of the initial laser beam. A processing module of a the ADV can determine a time-of-flight, from the time at which the laser beam was emitted until the time at which the peak magnitude of the focused reflection of the beam off of an object was detected. Cameras 211 may include one or more devices to capture images of the environment surrounding the autonomous vehicle. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

Sensor system 115 can detect obstacles surrounding an autonomous vehicle. Such obstacles can be taken into account by a least cost path module that emulates human driving behavior.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn control the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof. Steering unit 201 can be controlled, at least in part, by a least cost path module that participates in determining a path for navigating the ADV along a route.

Referring back to FIG. 1, wireless communication system 112 is to allow communication between autonomous vehicle 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of autonomous vehicle 101 may be controlled or managed by perception and planning system 110, especially when operating in an autonomous driving mode. Perception and planning system 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, perception and planning system 110 may be integrated with vehicle control system 111.

For example, a user as a passenger of an autonomous vehicle may specify a starting location and a destination of a trip, for example, via a user interface. Perception and planning system 110 obtains the trip related data. For example, perception and planning system 110 may obtain location and route information from an MPOI server, which may be a part of servers 103-104. The location server provides location services and the MPOI server provides map services and the POIs of certain locations. Alternatively, such location and MPOI information may be cached locally in a persistent storage device of perception and planning system 110.

While autonomous vehicle 101 is moving along the route, perception and planning system 110 may also obtain real-time traffic information from a traffic information system or server (TIS). Note that servers 103-104 may be operated by a third party entity. Alternatively, the functionalities of servers 103-104 may be integrated with perception and planning system 110. Based on the real-time traffic information, MPOI information, and location information, as well as real-time local environment data detected or sensed by sensor system 115 (e.g., obstacles, objects, nearby vehicles), perception and planning system 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either autonomous vehicles or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc. Data collector 121 may further receive LIDAR information from a LIDAR device in the sensor system 115 of the autonomous vehicle control system. LIDAR information may be transmitted to server 103 to update a high-definition (HD) map of objects surrounding the autonomous vehicle.

In an embodiment, data collector 121 can record data comprising driving statistics 123 for an initial path for a portion of an ADV route, and a selected least cost path for the portion of the route. And initial path can be, for example, a path that follows a centerline of a lane of roadway. Driving statistics 123 can also include sensor data and control input data associated with the ADV while it drives a path along the route. Driving statistics 123 for a path along the route can include speed, heading, steering input, braking input, if any, and sensor data including lateral forces, acceleration, and braking forces, and the like, such as may affect passenger comfort as the ADV drives along the least cost path. Machine learning engine 122 can use driving statistics 123 to generate algorithms and models 124 that can be used to upgrade ADV driving logic.

Algorithms 124 can then be uploaded on ADVs to be utilized during autonomous driving in real-time. In an embodiment, ADVs 101 can upload driving statistic data to server(s) 103 to facilitate crowd-sourced learning of algorithms and models 124 that can be downloaded to an ADV to update the ADV. For example, machine learning 122 can determine speed vs. steering input relationships that affect passenger comfort, wherein the speed and steering input are both within acceptable limits, but passenger comfort detected by IMUs or roll-pitch indicate levels that affect passenger comfort. Similarly, algorithms and models 124 can be determined that provide greater passenger comfort and greater speed with less turning angle using data produced by the least cost path module.

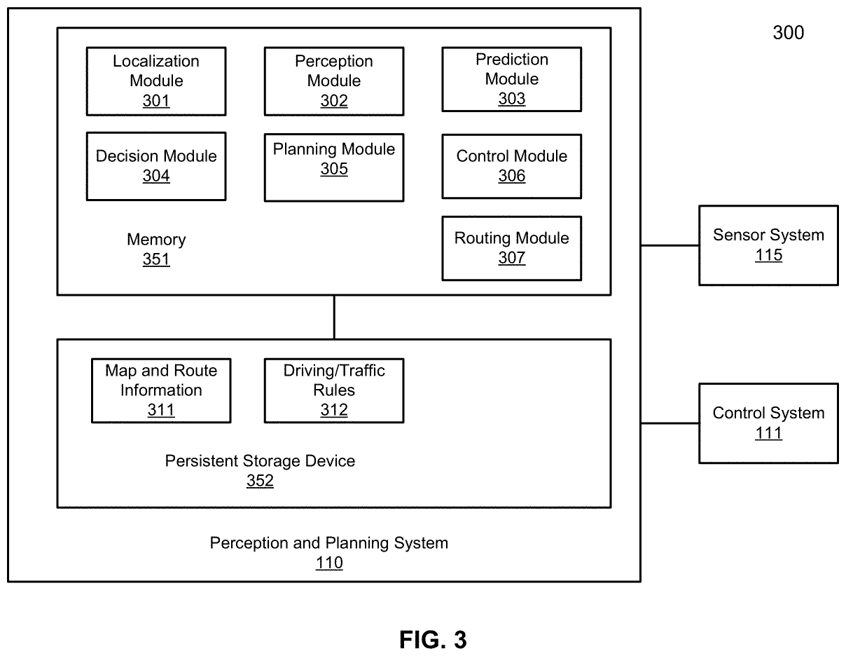

FIG. 3 is a block diagram illustrating an example of a perception and planning system used with an autonomous vehicle according to one embodiment. System 300 may be implemented as a part of autonomous vehicle 101 of FIG. 1 including, but is not limited to, perception and planning system 110, control system 111, and sensor system 115. Perception and planning system 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of autonomous vehicle 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of autonomous vehicle 300, such as map and route information 311, to obtain the trip related data. For example, localization module 301 may obtain location and route information from a location server and a map and POI (MPOI) server. A location server provides location services and an MPOI server provides map services and the POIs of certain locations, which may be cached as part of map and route information 311. While autonomous vehicle 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of autonomous vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR. A LIDAR device can include a LIDAR peak detector that utilizes a laser emitter that scans laser beams in a first plane, a linear diffuser that diffuses each emitted laser beam in a second plane that is perpendicular to the first plane, and focuses, onto a detect, a reflection of the diffused laser beam off of an object. The diffused reflected laser beam can be focused in the first plane, the second plane, or both.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305.

Based on a decision for each of the objects perceived, planning module 305 plans a path or route for the autonomous vehicle, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 mile per hour (mph), then change to a right lane at the speed of 25 mph.

Based on the planning and control data, control module 306 controls and drives the autonomous vehicle, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the autonomous vehicle. For example, the navigation system may determine a series of speeds and directional headings to affect movement of the autonomous vehicle along a path that substantially avoids perceived obstacles while generally advancing the autonomous vehicle along a roadway-based path leading to an ultimate destination. The destination may be set according to user inputs via user interface system 113. The navigation system may update the driving path dynamically while the autonomous vehicle is in operation. The navigation system can incorporate data from a GPS system and one or more maps so as to determine the driving path for the autonomous vehicle.

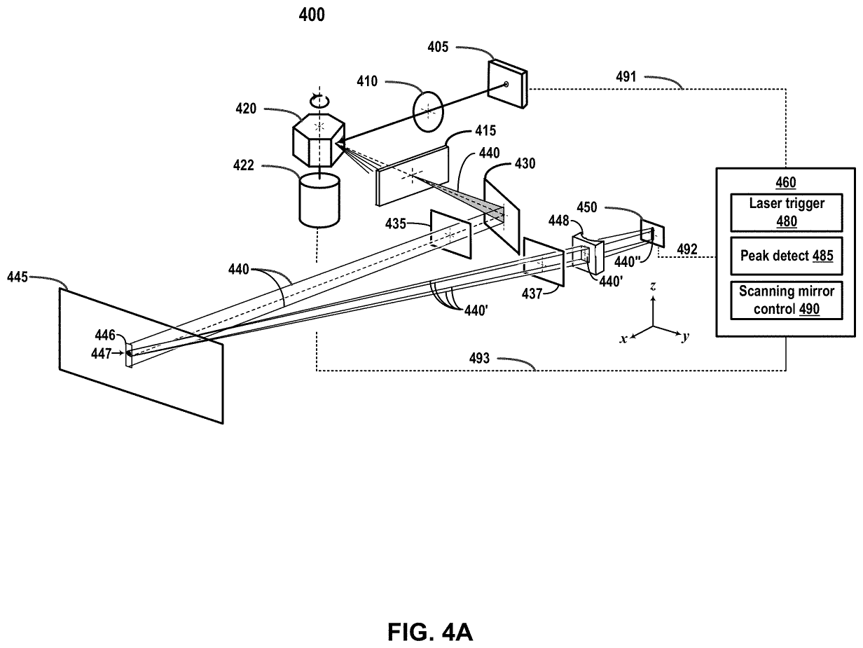

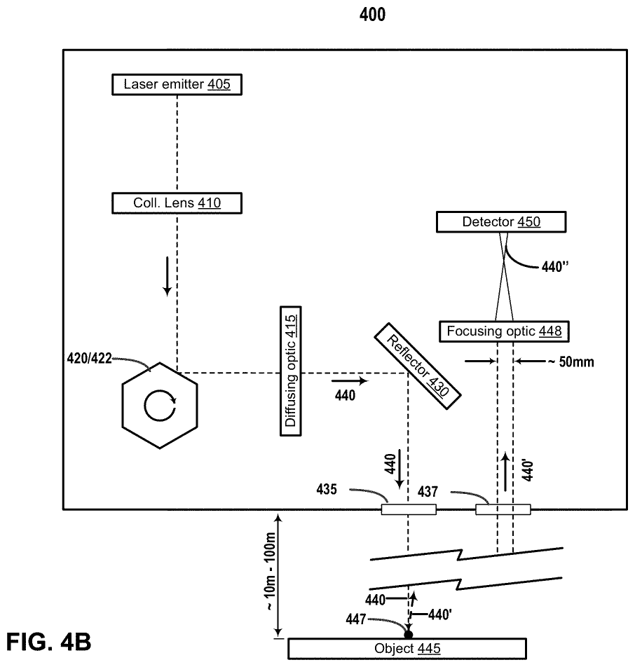

FIGS. 4A and 4B are block diagrams illustrating a LIDAR device 400 that incorporates a focusing lens, such as a cylindrical lens, and a diffuser to perform peak detection of a reflection of an initial laser beam off of an object scanned by the LIDAR sensor system in an ADV, according to one embodiment.

Referring now to FIGS. 4A ad 4B, in an embodiment, a LIDAR sensor system 215 can include LIDAR device 400. In an embodiment, LIDAR device 400 can include laser emitter 405, a scanning system 420, a diffusing optic 415, a focusing optic 448, a controller 460, and other optical, mechanical, and electrical components.

Laser emitted 405 can emit an initial beam 440 of a plurality of laser beams that scan an object 445. As each of the plurality of laser beams 440 is emitted, the laser beam can be collimated with collimating lens 410, and reflected by scanning mirror 420, through diffusing optic 415 and on to reflector 430. Scanning mirror 420 can scan the plurality of laser beams in a first plane. Diffusing optic 415 can diffuse each laser beam 440 in a second plane that is perpendicular to the first plane. Reflector 430 can reflect the diffused laser beam 440 through aperture 435, to an object 445. The distance of the diffused laser beam 440 to the object 445 can be, for example, from 10 meters (10m) to about 100 meters (100m). As the diffused laser beam travels to the object 445, it may broaden lightly, such that as the diffused laser beam 440 reaches the object 445 the diffused laser beam may be slightly rectangular at an area 446 if object 445 when it reflects off of the object 445. The surface of object 445 may be irregular such that portion 447 of the area 446 of the object 445 surface may reflect the diffused laser beam 440 more than other portions of the area 446. The reflection 440′ of the diffused laser beam 440, at the portion 447 that is more reflective than other portions of area 446, reflects toward LIDAR device aperture 437. Over the distance from the object 445 to the LIDAR device 400, the reflected diffused laser beam 440′ can be approximately collimated as it arrives at focusing optic 448 inside LIDAR device 400, via aperture 437. The approximately collimated, reflected, diffused laser beam 440′ can be approximately 50 millimeters (50 mm) wide as it enters the focusing optic 448. Focusing optic 448 can focus the reflected diffused laser beam 440′ in either, or both, of the first plane and the second plane. The focused reflected diffused laser beam 440″ can be detected by detector 450. As shown on FIG. 4B, focusing optic 448 can focus the reflected diffused laser beam 440′ at a point in front of detector 450. Alternatively, focusing optic 448 can focus the reflected diffused laser beam 440′ at a point behind (not shown) the detector 450. The diffusing optic 415 and focusing optic 448 ensure that a reflection 440′ of the diffused laser beam hits the detector 450 and does not “fall off” the detector 450.

Detector 450 can be a single photo detector or a small array of photo detectors, such an array of four (4) to sixty-four (64) photo detectors. Each photo detector can be a photodiode, or a combination of sensors, coupled to controller 460. Controller 460 can comprise a laser trigger 480 module, a peak magnitude detector 485, a scanning mirror control 490 module, and other processing modules.

Controller 460 can include a processing module that coordinates laser trigger 480 and peak detector 485 to determine, for each emitted laser beam 440, detection of a peak magnitude of the reflected focused laser beam 440″ detected by detector 450 and peak detector 485. Scanning mirror control 490 can control, via communication line 493 to motor 422, a rotation of scanning mirror 420 such that emitted lasers pulses 440 reflect off of scanning mirror 420 as scanning lines in a first plane. Controller 460, laser trigger 480, and peak detect module 485 can also determine a time-of-flight from when the laser beam 440 is emitted to the time when the peak magnitude of the reflected focused laser beam 440″ 445 is detected. Controller 460/laser trigger 480 can send a signal to emit a next laser beam via communication line 491. Peak detect module 485 can receive detector 450 information via communication line 492. Controller 460 can correlate the time-of-flight to the peak magnitude to a distance of the object 445 from the LIDAR device 400. Controller 460 can also correlate the distance of the object 4445 from the LIDAR device 400 with the peak magnitude to determine properties of the object 445. LIDAR information can include at least the distance to the object 445 and the properties of the object 445. LIDAR information is passed to the perception and planning system 110 to help determine one or more objects surrounding the ADV, for purposes of navigating the ADV.

Controller 460 can include a processor, memory, storage, one or more communication interfaces, a display, one or more input devices, one or more input/output (I/O) channels, one or more analog to digital convertor channels, one or more timer channels, an interrupt controller, and other components of a computing system. The processor may include one or more hardware processors which may include a central processing unit, a graphics processing unit, mathematical co-processor, or pipelined processor. Executable instructions may be stored on one or more non-transitory non-volatile storage devices. Communications interfaces can include WiFi, Ethernet, I²C, USB, RS485, etc. Memory can be read-only memory (ROM), random access memory (RAM), flash memory, static memory, and the like.

Controller 460 can include one or more input device(s) such as a mouse, a touch pad, a touch sensitive screen (which may be integrated with display device, a pointer device such as a stylus, and/or a keyboard (e.g., physical keyboard or a virtual keyboard displayed as part of a touch sensitive screen). For example, input device may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Input/Output (I/O) devices may include an audio device. An audio device may include a speaker and/or a microphone to facilitate voice-enabled functions, such as voice recognition, voice replication, digital recording, and/or telephony functions. Other I/O devices may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. I/O devices may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect via a sensor hub (not shown), while other devices such as a keyboard or thermal sensor may be controlled by an embedded controller (not shown), dependent upon the specific configuration or design of system.

Computer-readable storage medium may be used to store the some software functionalities described above persistently. While computer-readable storage medium is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, or any other non-transitory machine-readable medium.

Note that some or all of the components as shown and described above may be implemented in software, hardware, or a combination thereof. For example, such components can be implemented as software installed and stored in a persistent storage device, which can be loaded and executed in a memory by a processor to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

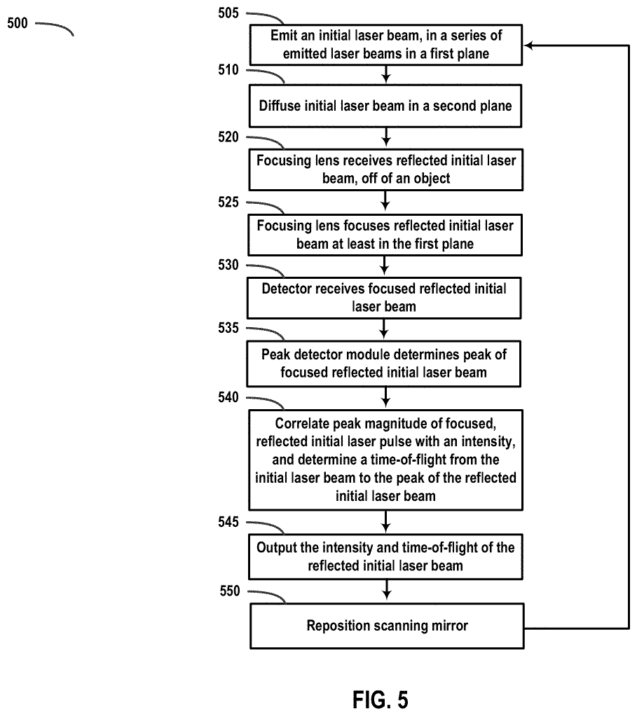

FIG. 5 illustrates a method 500 of determining a peak magnitude, and a time at which the peak magnitude occurs, in a LIDAR sensor system that incorporates a focusing lens and a diffuser to perform peak detection of a reflection of initial laser beam reflected off of an object scanned by a LIDAR system of an ADV, according to some embodiments.

In operation 505, laser emitter 405 can emit an initial laser beam 440. The initial laser beam 440 may be triggered by laser trigger module 480 of controller 460. Initial laser beam 440 may be passed through a collimating optic 410 to a scanning mirror, such as scanning mirror 420. Positioning of the scanning mirror 420 can be controlled by scanning mirror control 490 of controller 460. Scanning of a plurality of laser beams 440 can be in a first plane.

In operation 510, initial laser beam 440 can be diffused by diffusing optic 415 in a second plane that is perpendicular to the first (scanning) plane. The diffused laser beam 440 can be passed out of the LIDAR device 400 through an aperture 435 to an object 445, e.g., by reflecting initial laser beam 440 with a reflector 430. Initial laser beam 440 reflects off of object 445, such as at a point 447. The reflected initial laser beam 440′ enters the LIDAR device 400 through aperture 437, to focusing optic 448.

In operation 520, focusing optic 448 can receive the reflected initial laser beam 440′.

In operation 525, focusing optic 448 can focus the reflected initial laser beam 440′ in at least the first plane. Alternatively, or in addition, focusing optic 448 can focus the reflected initial laser beam 440′ in the second plane. A focal point of the focusing optic 448 can be slightly in front of, or slightly behind, the detector 450. Designing the focal point to be precisely at the face of the detector may damage the detector 450.

In operation 530, detector 450 receives the focused reflected initial laser beam 440″.

In operation 535, peak detector module 485 can read the one or more photo detectors of detector 450 to determine a peak magnitude of the focused reflected initial laser beam 440″ and a time at which the peak magnitude occurred, with respect to when the laser emitter emitted the initial laser pulse 440.

In operation 540, a processing module of controller 460 can correlate the peak magnitude of the focused reflected initial laser beam 440″ with an intensity. The peak detector module 485 can also determine a time-of-flight from the time of emitting initial laser beam to the time at which the peak magnitude occurred to determine a distance of the object 445 from the LIDAR device 400.

In operation 545, controller 460 can output LIDAR information including the peak magnitude and/or the intensity correlated to the peak magnitude, and the time-of-flight and/or distance of the object 445 from the LIDAR device 400, to the planning and perception system 115 of the ADV. The perception and planning system 115 can use the LIDAR information to determine one or more objects surrounding the ADV and navigate the ADV around the one or more obstacles.

In operation 550, scanning mirror control module 490 can position the scanning mirror 420, e.g. via motor 422, to prepare for emitting a next laser beam. Method 500 continues at operation 505.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A LIDAR device for use in an autonomous driving vehicle (ADV), comprising:
a laser emitter to emit a first laser beam of a sequence of laser beams, the sequence of laser beams emitted in a first plane;
a focusing optic that focuses a reflection of the first laser beam onto a detector that receives the focused reflection of the first laser beam off of an object;
a peak detection module configured to determine a peak magnitude of the focused reflection of the first laser beam off of the object, and a time at which the peak magnitude occurred, relative to a time when the first laser beam was emitted;
a processing module coupled to the detector and coupled to the peak detection module, the processing module configured to generate LIDAR information from the peak magnitude and the time at which the peak magnitude of the focused reflection of the first laser beam occurred, wherein the LIDAR information is utilized to navigate the ADV responsive to one or more obstacles detected by the LIDAR device.

2. The LIDAR device of claim 1, wherein the focusing optic comprises a concave lens or a convex lens.

3. The LIDAR device of claim 1, wherein the focusing optic comprises an imaging lens.

4. The LIDAR device of claim 1, wherein the focusing optic comprises a biconic lens.

5. The LIDAR device of claim 1, wherein the focusing optic focuses the reflection of the laser beam in the first plane.

6. The LIDAR device of claim 1, further comprising a diffusing optic that diffuses the first laser beam in a second plane, the second plane perpendicular to the first plane.

7. The LIDAR of claim 6, wherein the focusing optic further focuses the reflection of the diffused first laser beam in the second plane.

8. The LIDAR device of claim 6, wherein the diffusing optic comprises a linear diffuser.

9. The LIDAR device of claim 1, wherein the detector comprises an array of photo detectors.

10. The LIDAR device of claim 1, wherein the processing module is further configured to correlate the peak magnitude to an intensity of the focused reflection of the first laser beam.

11. An autonomous driving vehicle (ADV), comprising:
a light detection and range (LIDAR) device, wherein the LIDAR device comprises:
a laser transmitter to emit a first laser beam of a sequence of laser beams, the sequence of laser beams emitted in a first plane;
a focusing optic that focuses a reflection of the first laser beam onto a detector that receives the focused reflection of the first laser beam off of an object;
a peak detection module configured to determine a peak magnitude of the focused reflection of the first laser beam off of the object, and to determine a time at which the peak magnitude occurred, relative to a time at which the first laser beam was emitted;
a processing module coupled to the detector and coupled to the peak detection module, the processing module configured to generate LIDAR information from the peak magnitude and the time at which the peak magnitude of the focused reflection of the first laser beam occurred;
a perception and planning system coupled to the LIDAR device and configured to receive and utilize the LIDAR information to perceive a driving environment surrounding the ADV and to control the ADV to navigate the driving environment.

12. The ADV of claim 11, wherein the focusing optic comprises a concave lens or a convex lens.

13. The ADV of claim 11, wherein the focusing optic comprises an imaging lens.

14. The ADV of claim 11, wherein the focusing optic comprises a biconic lens.

15. The ADV of claim 11, wherein the focusing optic focuses the reflection of the first laser beam in the first plane.

16. The ADV of claim 11, wherein the LIDAR device further comprises a diffusing optic that diffuses the first laser beam in a second plane, the second plane perpendicular to the first plane.

17. The ADV of claim 16, wherein the focusing optic further focuses the reflection of the diffused first laser beam in the second plane.

18. The ADV of claim 11, wherein the diffusing optic comprise a linear diffuser.

19. A computer-implemented method, practiced on a LIDAR device comprising a laser emitter, a detector, a focusing optic, a peak detector module, and a processing module coupled to the peak detector module, the method comprising:
emitting, by the laser emitter, an first laser beam in a sequence of laser beams in a first plane;
focusing, by the focusing optic, a reflection of the first laser beam off of an object, onto the detector, the focusing at least in the first plane;
receiving, by the detector, the focused reflection of the first laser beam;
determining, by the peak detector module, a peak magnitude of the focused reflection of the first laser beam and a time at which the peak magnitude occurred relative to the emitting of the first laser beam;
generating, by the processing module, LIDAR information for the peak magnitude and a time-of-flight from emitting the first laser beam to the time at which the peak magnitude of the reflection of the first laser beam occurred, wherein LIDAR information is utilized to navigate the ADV responsive to one or more obstacles detected by the LIDAR device.

20. The method of claim 19, the LIDAR device further comprising a diffusing optic, the method further comprising:
diffusing, by the diffusing optic, the first laser beam in a second plane, the second plane perpendicular to the first plane

21. The method of claim 20, the focusing optic further focuses the reflection of the diffused first laser beam in the second plane.

22. The method of claim 19, wherein the focusing optic comprises one of a biconic lens, a concave lens, a convex lens, or an imaging lens.
